(19) United States
(12) Patent Application Publication
(10) Pub. No.: US 2025/0074730 A1
(43) Pub. Date: Mar. 6, 2025

(54) LOCK MECHANISM, HOUSING MECHANISM, AND MEDIUM CONVEYANCE DEVICE

(71) Applicant: SEIKO EPSON CORPORATION, Tokyo (JP)

(72) Inventors: Soichiro KII, SHIOJIRI-SHI (JP); Yusuke HIGUCHI, MATSUMOTO-SHI (JP); Kentaro NAKAMURA, SHIOJIRI-SHI (JP); Kazutoshi MATSUZAKI, SHIOJIRI-SHI (JP)

(21) Appl. No.: 18/824,169

(22) Filed: Sep. 4, 2024

(30) Foreign Application Priority Data
Sep. 4, 2023 (JP) 2023-142775

(51) Int. Cl. B65H 5/38

(52) U.S. Cl. CPC B65H 5/38; B65H 2402/441; B65H 2402/45; B65H 2402/60; B65H 2801/06

(57) ABSTRACT

A lock mechanism configured to lock a door part being openable and closable with respect to a device body in a closed state of being closed with respect to the device body, the lock mechanism including a first member including an engagement part being engageable with the device body, a first biasing member configured to bias the first member toward an engagement direction, a second member configured to displace the first member such that the engagement part shifts from an engaged state to a disengaged state with respect to the device body against a biasing force by the first biasing member, and a second biasing member configured to bias the second member in a direction not resisting the biasing force by the first biasing member.

The present application is based on, and claims priority from JP Application Serial Number 2023-142775, filed Sep. 4, 2023, the disclosure of which is hereby incorporated by reference herein in its entirety.

### BACKGROUND

### 1. Technical Field

The present disclosure relates to a lock mechanism, a housing mechanism, and a medium conveyance device.

### 2. Related Art

Various known lock mechanisms configured to lock a door part in a closed state of being closed with respect to a device body are used. For example, JP-A-2018-49144 discloses an image forming apparatus including a side cover as a door part and a hook member configured to lock the side cover in a closed state, the image forming apparatus configured to fix the side cover by latching the hook member to a device body side opening part when the side cover is in the closed state. The image forming apparatus of JP-A-2018-49144 has a configuration in which the hook member is biased by a coil spring, and a lever member rotates against a biasing force of a hook in the hook member when rotationally operated by a user. JP-A-2018-49144 discloses that sound is generated by contact between a support member of the side cover and the hook member.

However, as the image forming apparatus of JP-A-2018-49144, the known lock mechanism configured to lock a door part in the closed state of being closed with respect to the device body, it has been difficult to achieve both stability of a lock state of the lock mechanism and operation stability of an operation part configured to perform the operation.

### SUMMARY

A lock mechanism of the present disclosure for solving the above problem is a lock mechanism configured to lock a door part being openable and closable with respect to a device body in a closed state of being closed with respect to the device body, the lock mechanism including a first member having an engagement part being engageable with the device body, a first biasing member configured to bias the first member toward an engagement direction in which the engagement part engages with the device body, a second member configured to displace the first member such that the engagement part shifts from an engaged state to a disengaged state with respect to the device body against a biasing force by the first biasing member, and a second biasing member configured to bias the second member in a direction not resisting the biasing force by the first biasing member.

### BRIEF DESCRIPTION OF THE DRAWINGS

FIG. 1 is a view illustrating a medium conveyance path of a printer including a lock mechanism of Example 1 of the present disclosure.

FIG. 2 is a perspective view illustrating an external appearance of the printer of FIG. 1.

FIG. 3 is a perspective view illustrating a state in which a side door of the printer of FIG. 1 is opened.

FIG. 4 is a perspective view illustrating the lock mechanism of the printer of FIG. 1.

FIG. 5 is a plan view illustrating a periphery of the lock mechanism of the printer of FIG. 1, and is a view illustrating a state in which an operation lever is at an initial position and the side door is locked.

FIG. 6 is a plan view illustrating a periphery of the lock mechanism of the printer of FIG. 1, and is a view illustrating a state in which the operation lever is pivoted from the initial position and the side door is unlocked.

FIG. 7 is a plan view illustrating a periphery of an engagement part of the lock mechanism of the printer of FIG. 1.

FIG. 8 is a bottom view illustrating a periphery of the lock mechanism of the printer of FIG. 1, and is a view illustrating a state in which the operation lever is at the initial position and the side door is locked.

FIG. 9 is a perspective view illustrating a periphery of a linear member of the lock mechanism of the printer of FIG. 1.

FIG. 10 is a perspective view illustrating the periphery of the linear member of the lock mechanism of the printer of FIG. 1 as viewed from an angle different from that of FIG. 9.

FIG. 11 is a perspective view illustrating a periphery of the linear member of the lock mechanism of the printer of FIG. 1, and is a view illustrating a state of being attached with a frame.

FIG. 12 is an enlarged perspective view illustrating a periphery of the linear member of the lock mechanism of the printer of FIG. 1.

FIG. 13 is a side view illustrating a periphery of the linear member of the lock mechanism of the printer of FIG. 1.

FIG. 14 is a perspective view illustrating the linear member of the lock mechanism of the printer of FIG. 1.

FIG. 15 is a plan view illustrating a periphery of the linear member of the lock mechanism of the printer of FIG. 1.

FIG. 16 is a plan view illustrating a periphery of the linear member of the lock mechanism of the printer of FIG. 1, and is a view illustrating a state before being attached with an attachment screw of the linear member.

FIG. 17 is a side view illustrating an arrangement of the linear member of the lock mechanism of the printer of FIG. 1 with respect to the operation lever.

FIG. 18 is a perspective view illustrating an arrangement of the linear member of the lock mechanism of the printer of FIG. 1.

FIG. 19 is a perspective view illustrating an arrangement of the linear member of the lock mechanism of the printer of FIG. 1 with respect to the operation lever.

FIG. 20 is a perspective view illustrating a periphery of a linear member of a lock mechanism of Example 2 of the present disclosure.

FIG. 21 is a perspective view illustrating a periphery of a linear member of a lock mechanism of Example 3 of the present disclosure.

FIG. 22 is a perspective view illustrating a periphery of a linear member of a lock mechanism of Example 4 of the present disclosure.

### DESCRIPTION OF EMBODIMENTS

Hereinafter, the present disclosure will be schematically described.

The lock mechanism according to a first aspect is a lock mechanism configured to lock a door part being openable and closable with respect to a device body in a closed state of being closed with respect to the device body, the lock mechanism including a first member having an engagement part being engageable with the device body, a first biasing member configured to bias the first member toward an engagement direction in which the engagement part engages with the device body, a second member configured to displace the first member such that the engagement part shifts from an engaged state to a disengaged state with respect to the device body against a biasing force by the first biasing member, and a second biasing member configured to bias the second member, in which a biasing force of the second biasing member does not resist the biasing force by the first biasing member. In other words, a lock mechanism according to a first aspect is a lock mechanism configured to lock a door part being openable and closable with respect to a device body in a closed state of being closed with respect to the device body, the lock mechanism including a first member having an engagement part being engageable with the device body, a first biasing member configured to bias the first member toward an engagement direction in which the engagement part engages with the device body, a second member configured to displace the first member such that the engagement part shifts from an engaged state to a disengaged state with respect to the device body against a biasing force by the first biasing member, and a second biasing member configured to bias the second member in a direction not resisting the biasing force by the first biasing member.

According to the present aspect, a first member having an engagement part being engageable with the device body, a first biasing member configured to bias the first member toward an engagement direction in which the engagement part engages with the device body, a second member configured to displace the first member such that the engagement part shifts from an engaged state to a disengaged state with respect to the device body against a biasing force by the first biasing member, and a second biasing member configured to bias the second member in a direction not resisting the biasing force by the first biasing member are included. That is, the engagement part and the second member are biased by different biasing members. Such a configuration is configured to suppress displacement or the like of the second member from a desired position by the second biasing member while securing the engagement amount of the engagement part by the first biasing member. Therefore, it is configured to achieve both stability of the lock state of the lock mechanism and operation stability of the operation part or the like configured to perform the operation.

The lock mechanism according to a second aspect is an aspect dependent on the first aspect, in which the second biasing member is a linear member having a first end part attached to the door part and a second end part opposite to the first end part abutting on the second member.

According to the present aspect, the second biasing member is a linear member having the first end part attached to the door part and the second end part abutting on the second member. In this manner, by configuring the second biasing member with a wire rod, it is configured to easily form the second biasing member.

The lock mechanism according to a third aspect is an aspect dependent on the second aspect, in which the second end part is slidable with respect to the second member.

According to the present aspect, the second end part is slidable with respect to the second member. In this manner, by configuring the second end part to slide without being fixed, it is configured to easily attach the second biasing member to the lock mechanism.

The lock mechanism according to a fourth aspect is an aspect dependent on the third aspect, in which the second end part includes a bent part abutting on the second member.

According to the present aspect, the bent part of the second end part abuts on the second member. For example, when the tip end of the second end part is pointed, there is a possibility that the second end part is hooked by the second member when the second end part slides with respect to the second member. However, such a configuration is configured to facilitate sliding with respect to the second member.

The lock mechanism according to a fifth aspect is an aspect dependent on any one of the second to fourth aspects, in which the second biasing member includes a restricted part restricted from moving in a direction intersecting an extension direction of the second biasing member in a region between the first end part and the second end part.

According to the present aspect, the second biasing member includes a restricted part restricted from moving in a direction intersecting an extension direction of the second biasing member in a region between the first end part and the second end part. Since such a configuration restricts movement of the restricted part, the second biasing member is configured to bias the second member in a short part from the restricted part to the second end part. That is, the part involved in the biasing force is configured to be shortened, and the load is configured to be stabilized.

The lock mechanism according to a sixth aspect is an aspect dependent on any one of the second to fifth aspects, in which the second biasing member includes a deformation part in which the linear member is deformed in a region between the first end part and the second end part.

According to the present aspect, the second biasing member includes the deformation part in which the linear member is deformed to be easily elastically deformed in the region between the first end part and the second end part. With such a configuration, by deforming a substantially intermediate part of the linear member, for example, it is configured to shorten the part involved in the biasing force of the linear member, and it is configured to stably apply a desired load. Since the deformation part is easily elastically deformed, the displacement amount of the second end part is configured to be increased.

The lock mechanism according to a seventh aspect is an aspect dependent on any one of the first to sixth aspects, in which the first member includes a plurality of the engagement parts and a shaft part attached with the plurality of engagement parts.

According to the present aspect, the first member includes the plurality of engagement parts and the shaft part attached with the plurality of engagement parts. With such a configuration, by interlocking the plurality of engagement parts by the shaft part, for example, it is configured to perform locking more effectively.

The lock mechanism according to an eighth aspect is an aspect dependent on the seventh aspect, in which the first member includes a first abutment part on which the first biasing member abuts.

According to the present aspect, the first member includes the first abutment part on which the first biasing member abuts. With such a configuration, cost is configured to be suppressed by the first biasing member applying a biasing force to the plurality of engagement parts at one position, for example.

The lock mechanism according to a ninth aspect is an aspect dependent on the eighth aspect, in which the door part is openable and closable about a pivot shaft along a vertical direction, the shaft part extends along a vertical direction, and the first abutment part is provided between a plurality of the engagement parts in a vertical direction.

According to the present aspect, the door part is openable and closable about the pivot shaft along the vertical direction, the shaft part extends along the vertical direction, and the first abutment part is provided between the plurality of engagement parts in the vertical direction. With such a configuration, by providing the first abutment part between the plurality of engagement parts, the engagement part is configured to be provided further on an axial end side. Therefore, locking is configured to be performed more effectively.

The housing mechanism according to a 10th aspect includes the lock mechanism of the fifth aspect, the device body, the door part, and a sheet metal attached to the door part, in which the door part includes a first restricting part configured to restrict the restricted part from moving in a direction along the door part, and being positioned between the door part and the sheet metal, the restricted part is restricted from moving in a direction intersecting the door part.

According to the present aspect, the door part includes the first restricting part configured to restrict the restricted part from moving in the direction along the door part, and being positioned between the door part and the sheet metal, the restricted part is restricted from moving in the direction intersecting the door part. With such a configuration, since the restricted part is restricted from moving in the direction along the door part by the first restricting part of the door part, for example, and by being held between the door part and the sheet metal, the movement in the direction intersecting the door part is restricted. Due to this, the second biasing member is configured to more effectively bias the second member by the part from the restricted part to the second end part. That is, the part involved in the biasing force of the second biasing member is configured to be shortened, and the load is configured to be stabilized.

The housing mechanism according to an 11th aspect includes the lock mechanism of any one of the second to 10th aspects, the device body, and the door part, in which the door part includes a screw receiver and a second restricting part configured to restrict rotation of the first end part, the first end part is attached to the door part by being inserted into the screw receiver, and the second restricting part is configured to restrict rotation of the first end part inserted into the screw receiver.

According to the present aspect, the door part includes the screw receiver and the second restricting part configured to restrict rotation of the first end part, the first end part is attached to the door part by being inserted into the screw receiver, and the second restricting part is configured to restrict rotation of the first end part inserted into the screw receiver. With such a configuration, by inserting and screwing the first end part into the screw receiver, it is configured to easily assemble the second biasing member at a desired assembly position. Since the second restricting part is configured to restrict rotation of the first end part, the work at the time of screwing is facilitated.

The housing mechanism according to a 12th aspect includes the lock mechanism of any one of the first to 11th aspects, the device body, and the door part, in which the second member is an operation part for opening and closing the door part, and the door part includes a second abutment part on which the second member is configured to abut.

According to the present aspect, the second member is the operation part for opening and closing the door part, and the door part includes the second abutment part on which the second member is configured to abut. With such a configuration, the second member is configured to be biased by the second biasing member until the second member abuts on the second abutment part, and the position of the operation part with respect to the door part is configured to be stabilized.

The housing mechanism according to a 13th aspect is an aspect dependent on the 12th aspect, in which when the second member is abutting on the second abutment part, the operation part is flush with an outer surface of the door part.

According to the present aspect, when the second member is abutting on the second abutment part, the operation part is flush with the outer surface of the door part. With such a configuration, the operation part is configured to be brought into a state of being flush with the outer surface, and the appearance is configured to be improved.

The housing mechanism according to a 14th aspect is an aspect dependent on the 12th or 13th aspect, in which the second biasing member overlaps the second member as viewed in a direction intersecting an outer surface of the door part.

According to the present aspect, the second biasing member overlaps the second member as viewed in the direction intersecting the outer surface of the door part. With such a configuration, the second biasing member is configured to be made less visible in the appearance, and the appearance is configured to be improved.

The medium conveyance device according to a 15th aspect includes the housing mechanism of the 11th aspect and a conveyance unit configured to convey a medium, in which the door part forms at least a part of a conveyance path through which a medium is conveyed by the conveyance unit.

According to present aspect, the door part forms at least the part of the conveyance path through which the medium is conveyed by the conveyance unit. With such a configuration, the conveyance path is configured to be opened by opening and closing the door part, for example, and jam processing and the like is configured to be easily performed.

A medium conveyance device according to a 16th aspect includes the housing mechanism of any one of the 12th to 15th aspects, and a conveyance unit configured to convey a medium, in which the door part forms at least a part of a conveyance path through which a medium is conveyed by the conveyance unit.

According to present aspect, the door part forms at least the part of the conveyance path through which the medium is conveyed by the conveyance unit. With such a configuration, the conveyance path is configured to be opened by opening and closing the door part, for example, and jam processing and the like is configured to be easily performed.

### Example 1

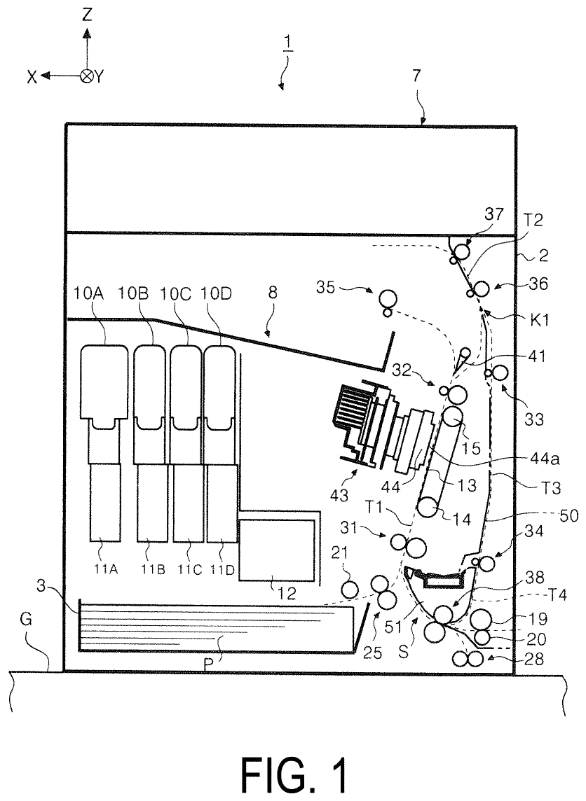

Hereinafter, the present disclosure will be specifically described. First, an outline of an inkjet printer 1 including a lock mechanism 100 of Example 1, which is an example of the lock mechanism of the present disclosure, will be described with reference to FIGS. 1 to 3. The inkjet printer 1 is an inkjet printer configured to perform recording by conveying a medium P represented by a recording sheet and ejecting ink, which is an example of liquid, onto the medium P to be conveyed, and t inkjet printer 1 is an example of a medium conveyance device and a recording device. Hereinafter, the inkjet printer 1 is abbreviated as the printer 1. The X-Y-Z coordinate system illustrated in each drawing is an orthogonal coordinate system, and the Y-axis direction is a direction intersecting the conveyance direction of the medium P, that is, the medium width direction, and is also a device depth direction. In the Y-axis direction, the +Y direction is a direction from the device front surface toward the device back surface, and the −Y direction is a direction from the device back surface toward the device front surface.

The X-axis direction is a device width direction, and the +X direction is the left side and the −X direction is the right side as viewed from the operator of the printer 1. The Z-axis direction is a vertical direction, and is a normal direction with respect to a placement surface G of the printer 1, that is, a device height direction. In the Z-axis direction, the +Z direction is an upward direction, and the −Z direction is a downward direction. Hereinafter, the direction in which the medium P is fed may be called “downstream”, and the opposite direction thereof may be called “upstream”. In FIG. 1, the medium conveyance path is indicated by a broken line. In the printer 1, the medium P is conveyed through a medium conveyance path indicated by the broken line in FIG. 1.

The printer 1 is a multifunction peripheral including a scanner unit 7, which is an example of an image reading device, on an upper part of a device body 2. The printer 1 is configured such that an extension unit not illustrated is configured to be coupled to a lower part of the device body 2, and is configured such that the medium P is configured to be fed from this extension unit. In FIG. 1, reference sign 28 denotes a conveyance roller pair configured to send, into the device body 2, the medium P fed from the extension unit not illustrated.

The device body 2 includes a first medium cassette 3 configured to store the medium P in a lower part. The first medium cassette 3 is provided with a pick roller 21 configured to send the stored medium P in the −X direction. The medium P sent by the pick roller 21 is sent toward a conveyance roller pair 31 by a feed roller pair 25. In the following, unless otherwise specified, the “roller pair” includes a driving roller driven by a drive source not illustrated to apply a feeding force to the medium P and a driven roller driven to rotate in contact with this driving roller or the medium P. A supply roller 19 and a separation roller 20 provided in the vicinity of a conveyance roller pair 38 are a roller pair configured to send the medium P from a supply tray not illustrated in FIG. 1.

The medium P receiving the feeding force from the conveyance roller pair 31 is sent between a line head 44, which is an example of a recording head, and a conveyance belt 13, that is, to a position facing the line head 44. Hereinafter, the medium conveyance path from the conveyance roller pair 31 to a conveyance roller pair 32 is called a recording conveyance path T1. The line head 44 is an example of a recording unit configured to perform recording on the medium P stored in the device body 2 and conveyed along the recording conveyance path T1, and the line head 44 constitutes a head unit 43. The line head 44 is an ink ejection head configured such that a nozzle configured to eject ink covers the entire area in the medium width direction, and the line head 44 is configured as an ink ejection head configured to performing recording in the entire medium width without accompanying a movement in the medium width direction. However, the ink ejection head is not limited to this, and may be a type that is mounted on a carriage and ejects ink while moving in the medium width direction.

The head unit 43 is provided to be movable forward and backward with respect to the recording conveyance path T1, and is provided to be movable between a recording position where the head unit 43 advances to the recording conveyance path T1 to perform recording on the medium P and a retraction position where the head unit 43 retracts from the recording conveyance path T1. FIG. 1 illustrates a state in which the head unit 43 is at the recording position, and recording is performed on the medium P in this state.

Reference signs 10A, 10B, 10C, and 10D denote ink storage units as liquid storage units. The ink ejected from the line head 44 is supplied from each ink storage unit to the line head 44 via a tube not illustrated. The ink storage units 10A, 10B, 10C, and 10D are detachably provided to attachment parts 11A, 11B, 11C, and 11D, respectively. Reference sign 12 denotes a waste liquid storage unit configured to store ink as waste liquid ejected, for maintenance, from the line head 44 toward a flushing cap not illustrated.

The conveyance belt 13 is an endless belt wound around a pulley 14 and a pulley 15, and rotates when at least one of the pulley 14 and the pulley 15 is driven by a motor not illustrated. The medium P is conveyed at a position facing the line head 44 while being adsorbed to a belt surface of the conveyance belt 13. A known adsorption method such as an air suction method or an electrostatic adsorption method is configured to be adopted for the adsorption of the medium P with respect to the conveyance belt 13. The conveyance belt 13 is an example of a medium support unit supporting the medium P.

Here, the recording conveyance path T1 passing through the position facing the line head 44 intersects both the horizontal direction and the vertical direction and conveys the medium P upward. Therefore, an ejection surface 44a ejecting ink in the line head 44 also intersects both the horizontal direction and the vertical direction.

The medium P on which recording was performed on a first surface by the line head 44 is further sent upward by the conveyance roller pair 32 positioned downstream of the conveyance belt 13. Downstream of the conveyance roller pair 32 is provided with a flap 41, and the conveyance direction of the medium P is switched by this flap 41. When the medium P is discharged as it is, the conveyance path of the medium P is switched by the flap 41 toward a conveyance roller pair 35 upward, and the medium P is discharged toward a discharge tray 8 by the conveyance roller pair 35.

When recording is further performed on a second surface in addition to the first surface of the medium P, the conveyance direction of the medium P is directed to a branch position K1 by the flap 41. Then, the medium P passes through the branch position K1 and enters a switchback path T2. In the present embodiment, the switchback path T2 is a medium conveyance path on an upper side relative to the branch position K1. The switchback path T2 is provided with conveyance roller pairs 36 and 37. The medium P entered the switchback path T2 is conveyed upward by the conveyance roller pairs 36 and 37, and when a lower edge of the medium P passes through the branch position K1, the rotation direction of the conveyance roller pairs 36 and 37 is switched, and thus the medium P is conveyed downward.

A coupling path T3 is coupled to the switchback path T2. In the present embodiment, the coupling path T3 is a medium conveyance path from the branch position K1 to the conveyance roller pair 34. An inversion path T4 is coupled to the coupling path T3. In the present embodiment, the inversion path T4 is a medium conveyance path from the conveyance roller pair 34 to the conveyance roller pair 31 through the conveyance roller pair 38. The inversion path T4 is a conveyance path upstream relative to a position facing the line head 44, and is a conveyance path positioned vertically downward relative to the line head 44. The inversion path T4 includes a path part S that is a path part protruding vertically downward and curves and inverts upward the medium P. In the present embodiment, the entire inversion path T4 is configured to be the path part S, but the path part S may constitute a part of the inversion path T4. The medium P conveyed downward from the branching position K1 receives the feeding force from the conveyance roller pair 33 and 34, reaches the conveyance roller pair 38, is curved and inverted, and is sent to the conveyance roller pair 31.

In the medium P sent again to the position facing the line head 44, the second surface on the opposite side to the first surface on which recording was already performed faces the line head 44. This enables recording by the line head 44 on the second surface of the medium P.

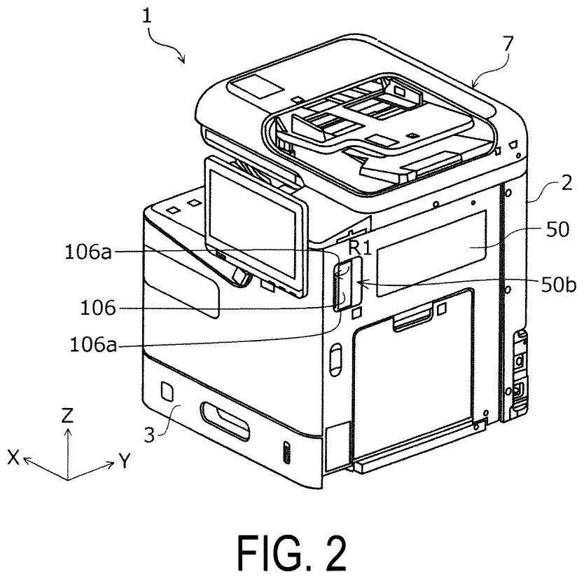

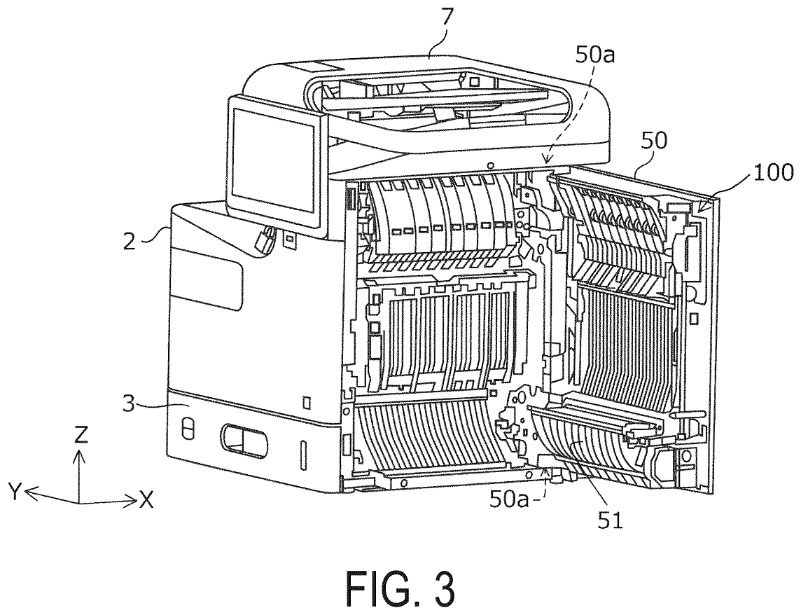

As illustrated in FIGS. 2 and 3, a side surface in the −X direction of the device body 2, that is, a right side surface is provided with a side door 50 as a door part being openable and closable with respect to the device body 2. Inside of the device body 2 is exposed by pivoting and opening the side door 50 from the state illustrated in FIG. 2 to the state illustrated in FIG. 3 with reference to a pivot shaft 50a along the Z-axis direction illustrated in FIG. 3. As illustrated in FIG. 3, an open end side of the side door 50 on a side opposite to the pivot shaft 50a is provided with the lock mechanism 100 configured to lock the side door 50 in a closed state of being closed with respect to the device body 2. As illustrated in FIG. 2, the side door 50 is provided with an operation lever 106 as an operation part configured to be operated by the user inserting a hand from an insertion part 50b and pulling the hand from the inside to the outside. When the user pivots the operation lever 106 in a pivot direction R1 with reference to a pivot shaft 106a, the lock mechanism 100 is unlocked. The pivot direction R1 is a clockwise direction in plan view, and a pivot direction R2 described later is a counterclockwise direction in plan view.

As illustrated in FIG. 1, the side door 50 includes rollers in the −X direction of the conveyance roller pairs 36 and 37, the conveyance roller pairs 33 and 34, the supply roller 19, the separation roller 20, and rollers in the +Z direction of the conveyance roller pair 38. When the side door 50 is opened, the switchback path T2 is opened, and a part of the coupling path T3 and a part of the inversion path T4 are opened. Due to this, for example, when a paper jam occurs in the coupling path T3 and the inversion path T4, the jammed sheet is configured to be removed. A lower part of the side door 50 is provided with a path forming member 51. The path forming member 51 is a member forming the inside of the inversion path T4, and has a shape protruding vertically downward.

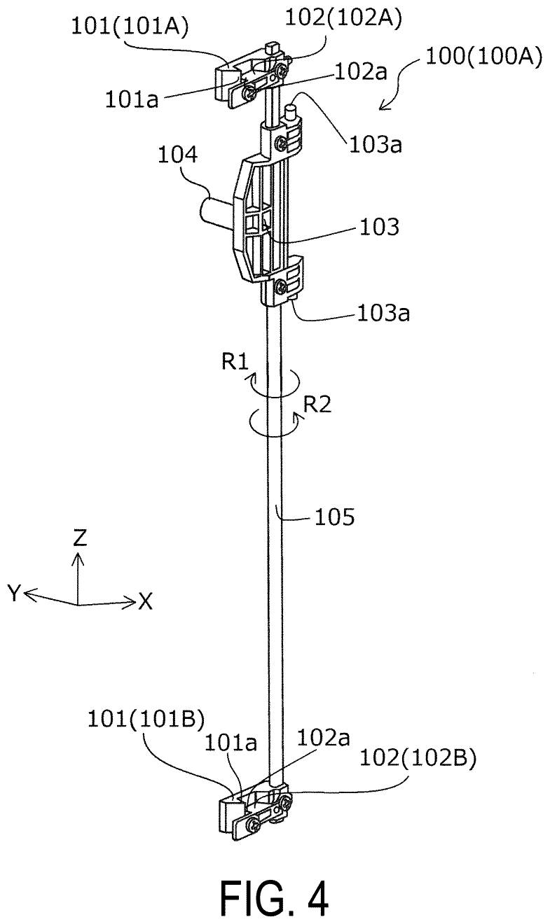

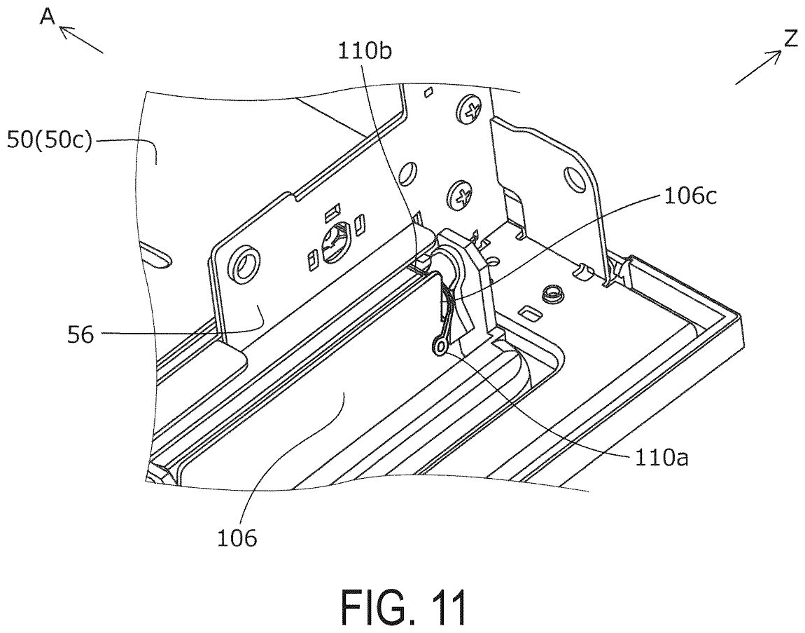

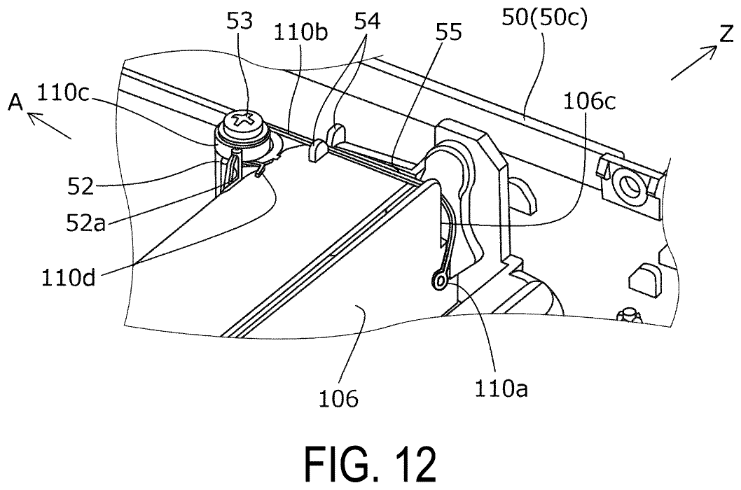

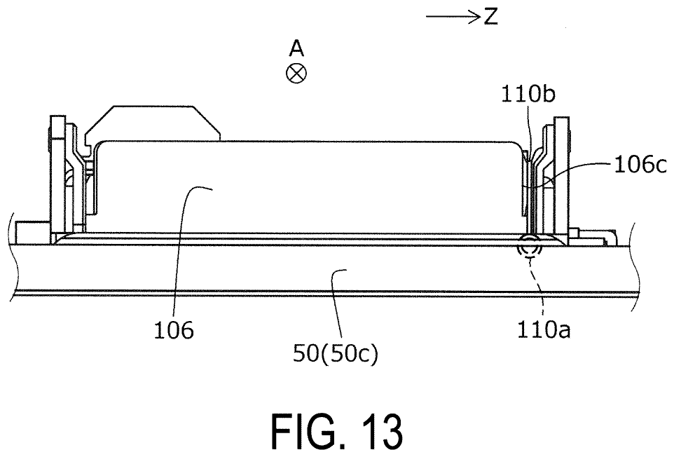

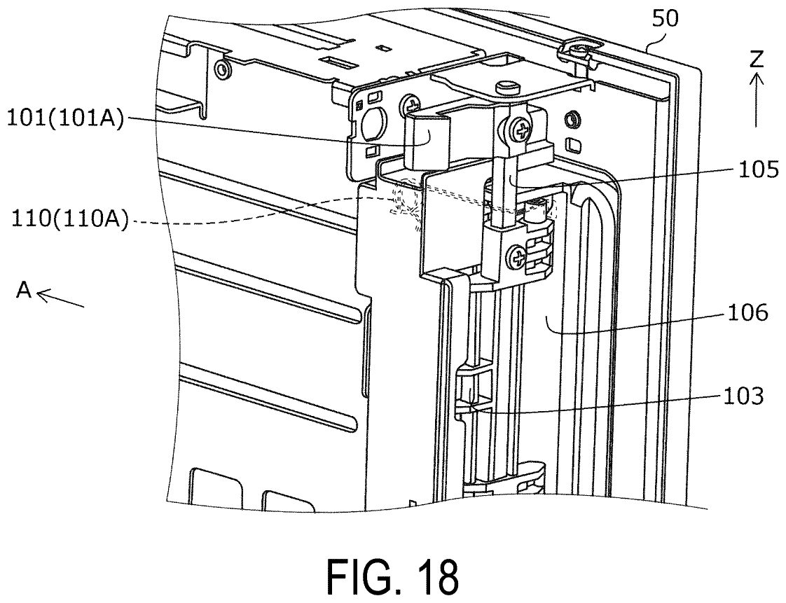

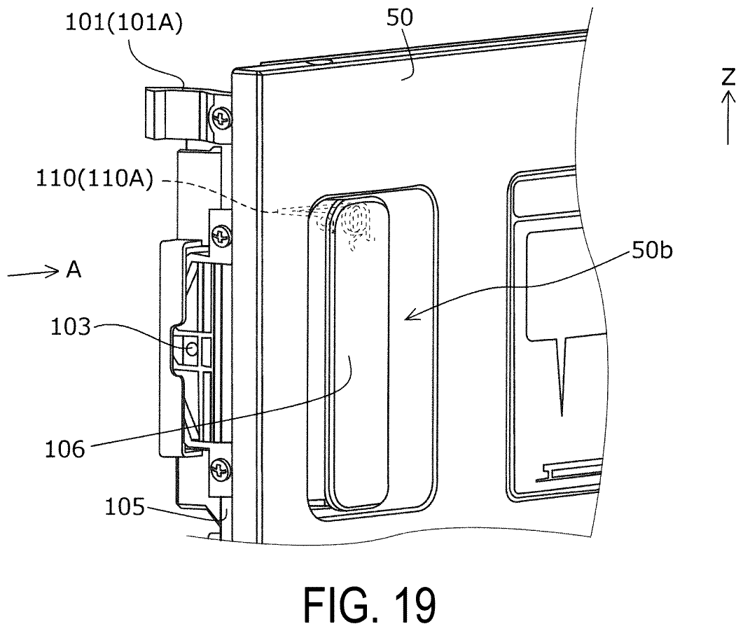

Hereinafter, the lock mechanism 100 of Example 1 will be described in more detail with reference to FIGS. 4 to 19. As illustrated in FIG. 4 and the like, the lock mechanism 100 of the present example includes a first member 100A, and includes, as the first member 100A, a pivot shaft 105, two hook members 101 attached to the pivot shaft 105, and a rotation transmission member 103 attached to the pivot shaft 105. Hook members 101A and 101B as the hook member 101 and the rotation transmission member 103 integrally pivot as the pivot shaft 105 is pivoted in the pivot direction R1 and the pivot direction R2.

A hook engagement member 102 is provided at a position facing the hook member 101 in a frame not illustrated of the device body 2 when the side door 50 is brought into a closed state. For easy understanding of the arrangement of the hook engagement member 102, FIG. 4 illustrates, together with the hook member 101, the hook engagement member 102 originally provided in the frame not illustrated of the device body 2. The hook engagement member 102 includes a hook engagement member 102A engaging with the hook member 101A and a hook engagement member 102B engaging with the hook member 101B.

The hook member 101A and the hook member 101B have the same shape, and the hook engagement member 102A and the hook engagement member 102B have the same shape. The hook member 101A and the hook member 101B have an engagement part 101a, and the hook engagement member 102A and the hook engagement member 102B have an engaged part 102a. When the engagement part 101a and the engaged part 102a engage with each other, a lock state is established. When the engagement part 101a and the engaged part 102a are disengaged, an unlock state is established. FIG. 4 illustrates a lock state.

When the side door 50 is brought into the closed state, a pressing spring 104 is provided at a position facing the rotation transmission member 103 in the frame not illustrated of the device body 2. The pressing spring 104 presses the rotation transmission member 103 in a direction in which the rotation transmission member 103 pivots in the pivot direction R2. As described above, since the hook member 101, the rotation transmission member 103, and the pivot shaft 105 pivot integrally, when the rotation transmission member 103 is pressed in the pivot direction R2, the hook member 101 is also pressed in the pivot direction R2 via the pivot shaft 105. That is, when the side door 50 is brought into the closed state, the hook member 101 is applied with a force so as to be in the lock state by the hook member 101 being pressed in the pivot direction R2.

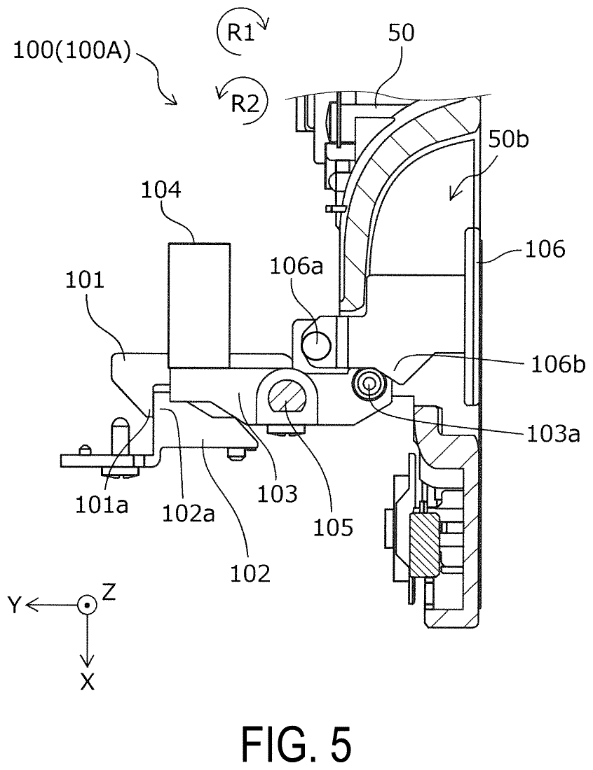

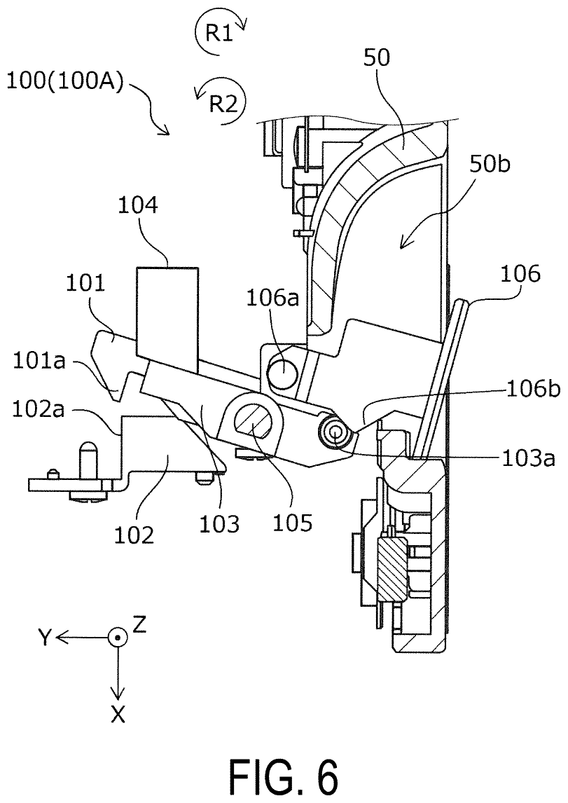

FIG. 5 is a view illustrating a state in which the operation lever 106 is at the initial position and the side door 50 is locked, and FIG. 6 is a view illustrating a state in which the operation lever 106 is pivoted in the pivot direction R1 from the initial position and the side door 50 is unlocked. By inserting a hand from the insertion part 50b and pulling the operation lever 106 from the inside to the outside, the user can displace the first member 100A of the lock mechanism 100 from the lock state illustrated in FIG. 5 to the unlock state illustrated in FIG. 6.

At this time, the operation lever 106 pivots in the pivot direction R1 with reference to the pivot shaft 106a, and an abutment part 106b provided at the operation lever 106 presses an abutted part 103a provided at the rotation transmission member 103, thus the rotation transmission member 103 also pivots in the pivot direction R1 with reference to the pivot shaft 105. When the rotation transmission member 103 pivots in the pivot direction R1, the pivot shaft 105 also pivots in the pivot direction R1, and further, the hook member 101 also pivots in the pivot direction R1 along with the pivot of the pivot shaft 105.

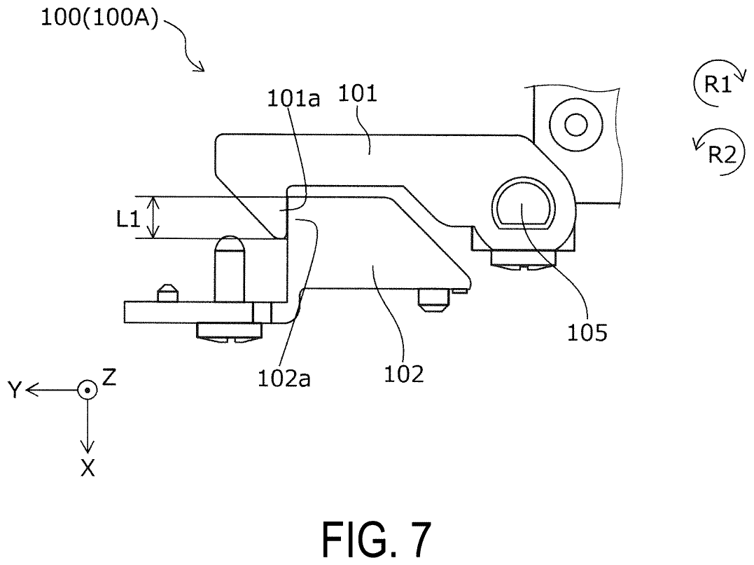

As illustrated in FIGS. 5 and 7, when the first member 100A is in the lock state, the engagement part 101a of the hook member 101 engages with the engaged part 102a of the hook engagement member 102. An engagement amount L1, which is a facing length in the X-axis direction of the engagement part 101a and the engaged part 102a as illustrated in FIG. 7, is called a fit amount. When the fit amount is short, the lock is easily released in the lock state. Therefore, as illustrated in FIGS. 5 and 6, the rotation transmission member 103 is abutting on the pressing spring 104, and a force is applied from the pressing spring 104 so that the rotation transmission member 103 pivots in the pivot direction R2. The pressing spring 104 presses the hook member 101 to pivot in the pivot direction R2 via the rotation transmission member 103, and thus the fit amount in the lock state is suppressed from being shortened.

As described above, the first member 100A of the present example is configured to be displaced between the lock state and the unlock state in conjunction with the pivot of the operation lever 106. In such a configuration, when the position of the abutment part 106b of the operation lever 106 and the position of the abutted part 103a of the rotation transmission member 103 are deviated due to design tolerance or the like, there is a possibility that rattling occurs in the operation lever 106. On the other hand, when the abutment part 106b is configured to abut on the abutted part 103a in a state where a predetermined pressure is applied in advance in order to suppress the rattling, the fit amount tends to be short. In particular, in the printer 1 of the present example, since the operation lever 106 is made of resin and the hook member 101 is made of metal, an occurrence of rattling and shortening of the fit amount can occur due to a change in environmental temperature or the like because of a difference in thermal expansion coefficient. Therefore, the lock mechanism 100 of the present example includes a linear member 110 configured to apply a force so that the operation lever 106 pivots in the pivot direction R2 with reference to the pivot shaft 106a, separately from the pressing spring 104 configured to apply a force so that the hook member 101 pivots in the pivot direction R2 with reference to the pivot shaft 105.

In other words, the lock mechanism 100 of the present example includes the first member 100A having the hook member 101 provided with the engagement part 101a being engageable with the engaged part 102a of the hook engagement member 102 of the device body 2, and the pressing spring 104 as a first biasing member configured to bias the first member 100A toward the pivot direction R2, which is the engagement direction in which the engagement part 101a engages with the engaged part 102a. The lock mechanism 100 of the present example includes the operation lever 106 as a second member configured to displace the first member 100A such that the engagement part 101a shifts from the engaged state to the disengaged state with respect to the engaged part 102a against the biasing force by the pressing spring 104, and the linear member 110 as a second biasing member configured to bias the operation lever 106 in a direction not resisting the biasing force of the pressing spring 104.

That is, the lock mechanism 100 of the present example is configured to bias the first member 100A and the operation lever 106 with different biasing members. Such a configuration is configured to suppress displacement or the like of the operation lever 106 from a desired position by the linear member 110 while securing the engagement amount L1 (fit amount) of the engagement part 101a by the pressing spring 104. Therefore, it is configured to achieve both the stability of the lock state of the lock mechanism 100 and the operation stability of the operation part or the like configured to perform the operation such as the rattling suppression of the operation lever 106.

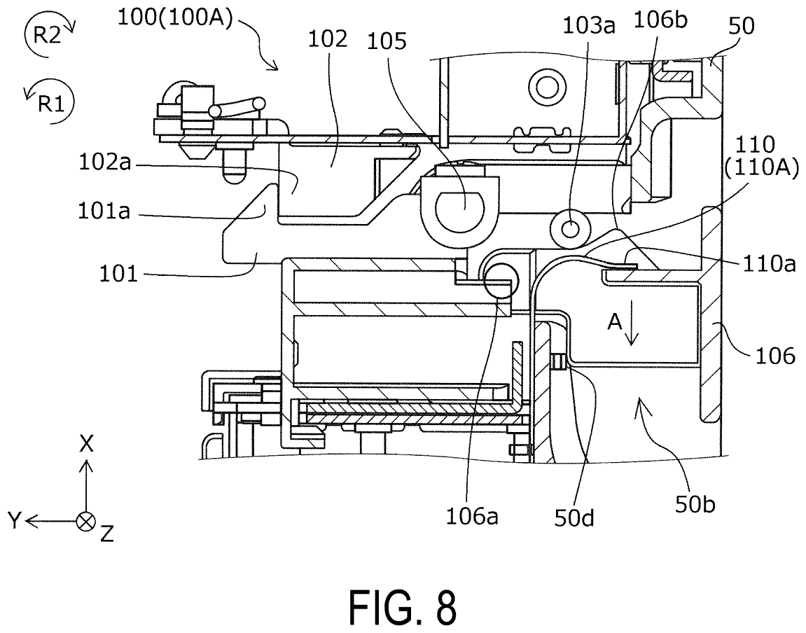

Hereinafter, the linear member 110A, which is the linear member 110 as the second biasing member, will be described with reference to FIGS. 8 to 19. In the present example, the second biasing member is a linear spring member, but is not limited to such a configuration. For example, the second biasing member may be a coil spring, and the coil spring may adsorb or press the second member such as the operation lever 106. In the present example, the second member also serves as a handle for opening a door part such as the side door 50, but is not limited to such a configuration. For example, a handle for opening the door part may be separately provided, and the second member may be specialized in a role for releasing the lock state of the lock mechanism 100 without also serving as the handle. Furthermore, the rotation transmission member 103 constituting the first member 100A and the operation lever 106 as the second member may be configured not to abut each other but another member may be configured to be interposed between the first member and the second member.

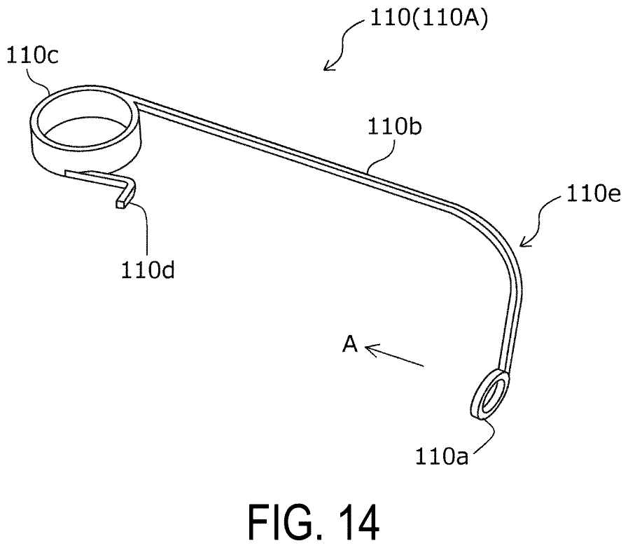

As illustrated in FIG. 14, the linear member 110A of the present example is formed by processing one linear metal, and includes a tip end part 110a bent in an annular shape, a linear part 110b bent by approximately 90° at a bend part 110e, an attachment part 110c wound spirally, and a hook part 110d. Because of being bent via the bend part 110e, the linear member 110A attached to the side door 50 in the attachment part 110c is configured to be biased in a bias direction A at the tip end part 110a.

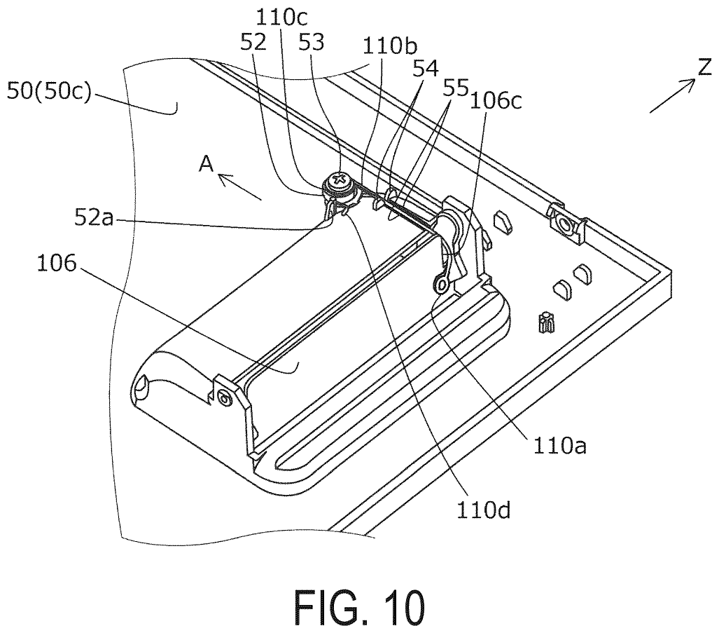

Specifically, as illustrated in FIG. 10 and the like, in the lock mechanism 100 of the present example, the linear member 110A is a linear member in which the attachment part 110c as a first end part is attached to a cover part 50c of the side door 50, and the tip end part 110a as a second end part opposite to the first end part abuts on the operation lever 106. Specifically, the attachment part 110c is attached to a screw receiver 52 described later. In this manner, by configuring the second biasing member with a wire rod, it is configured to easily form the second biasing member. The lock mechanism 100 of the present example is configured to reduce a space occupied by the second biasing member as compared with a configuration using a coil spring or the like as the second biasing member. Therefore, the lock mechanism 100 and the side door 50 are configured to be downsized. In the present example, the tip end part 110a is configured to be pressed against the operation lever 106 by a spring force of the linear member 110, but the tip end part 110a may also be attached to the operation lever 106.

However, as the lock mechanism 100 of the present example, the tip end part 110a may be slidable with respect to the operation lever 106. This is because the linear member 110 is configured to be easily attached to the lock mechanism 100 by configuring the tip end part 110a to slide without being fixed to the operation lever 106.

As described above, in the lock mechanism 100 of the present example, the tip end part 110a is configured to be bent in an annular shape, and in other words, configured to have a bent part abutting on the operation lever 106. For example, in a case where the tip end of the tip end part 110a is pointed, there is a possibility that the tip end part 110a is hooked by the operation lever 106 when the tip end part 110a slides with respect to the operation lever 106. However, such a configuration is configured to cause the tip end part 110a to easily slide with respect to the operation lever 106. In the present example, the tip end part 110a has a bent part abutting on the operation lever 106, but is not limited to such a configuration. For example, a separate member abutting on the operation lever 106 may be attached to the tip end of the tip end part 110a or the like to facilitate sliding with respect to the operation lever 106.

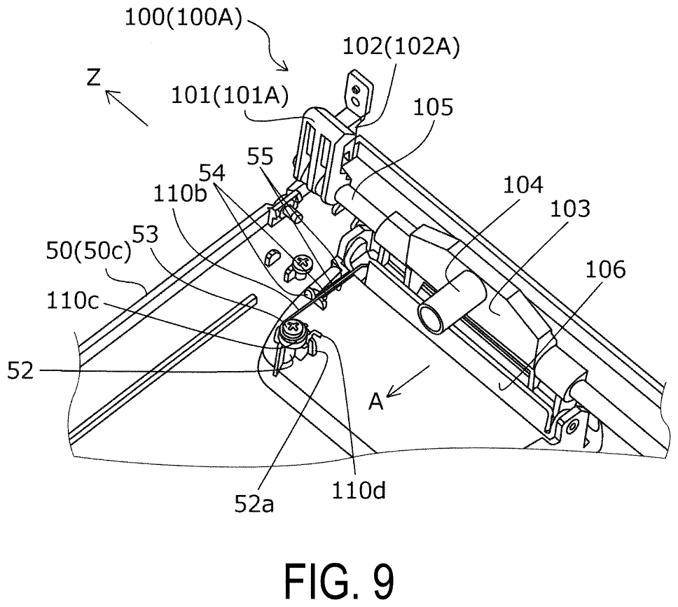

As illustrated in FIGS. 9 to 13, in the lock mechanism 100 of the present example, in order to restrict movement of the linear member 110, a protrusion part 54 and a groove part 55 are formed in the cover part 50c of the side door 50, a slit 106c is formed at the operation lever 106, and a frame 56 holding the linear member 110 together with the cover part 50c of the side door 50 is formed. Describing from the viewpoint of the linear member 110, in the lock mechanism 100 of the present example, the linear member 110A has a restricted part restricted from moving in a direction intersecting the extension direction of the linear member 110 in a region between the attachment part 110c and the tip end part 110a. The Z-axis direction and the X-axis direction in a state where the side door is closed are examples of directions intersecting with the extension direction of the linear member 110. The restricted part corresponds to the linear part 110b.

As in the present example, by restricting movement of the linear part 110b as the restricted part with such a configuration, the linear member 110A is configured to bias the operation lever 106 in a short part from the linear part 110b to the tip end part 110a. That is, the part involved in the biasing force is configured to be shortened, and the load is configured to be stabilized. In the present example, the linear part 110b includes a part held by the protrusion part 54 provided in the cover part 50c of the side door 50, a part inserted into the groove part 55, a part pressed by the frame 56, and a part held by the slit 106c of the operation lever 106. However, all of these components need not necessarily be included. The protrusion part 54 provided on the cover part 50c of the side door 50 may be separated as much as possible from the screw receiver 52 attached with the attachment part 110c and may be close to the slit 106c of the operation lever 106. This is because such an arrangement enables the lock mechanism 100 to be easily assembled, and the extension direction of the linear member 110 to be stabilized. The protrusion part 54 provided on the cover part 50c of the side door 50 may be on the screw receiver 52 side rather than the position pressed by the frame 56. This is because a necessary load is configured to be applied to the operation lever 106 and an unnecessary load is less likely to be applied.

Describing the above from the viewpoint of the housing mechanism, the printer 1 of the present example includes, as the housing mechanism, the lock mechanism 100, the outer cover of the device body 2, the side door 50 being openable and closable with respect to the device body 2, and the frame 56 attached to the side door 50. The side door 50 includes the protrusion part 54, the groove part 55, and the slit 106c as the first restricting part restricting movement in the direction along the side door 50 (Z-axis direction) of the linear part 110b, which is the restricted part, and the linear part 110b is positioned between the cover part 50c of the side door 50 and the frame 56, and thus the movement in the direction (X-axis direction) intersecting the side door 50 is restricted.

With such a configuration, for example, the linear part 110b is restricted from moving in the direction (Z-axis direction) along the side door 50 in the direction intersecting the extension direction of the linear member 110 by the protrusion part 54 of the cover part 50c of the side door 50, and is held between the cover part 50c of the side door 50 and the frame 56, whereby the linear part 110b is restricted from moving in the direction (X-axis direction) intersecting the side door 50 in the direction intersecting the extension direction of the linear member 110. Thus, the linear member 110 is configured to more effectively bias the operation lever 106 by the part from the linear part 110b to the tip end part 110a. That is, the part involved in the biasing force of the linear member 110 is configured to be shortened, and the load is configured to be stabilized.

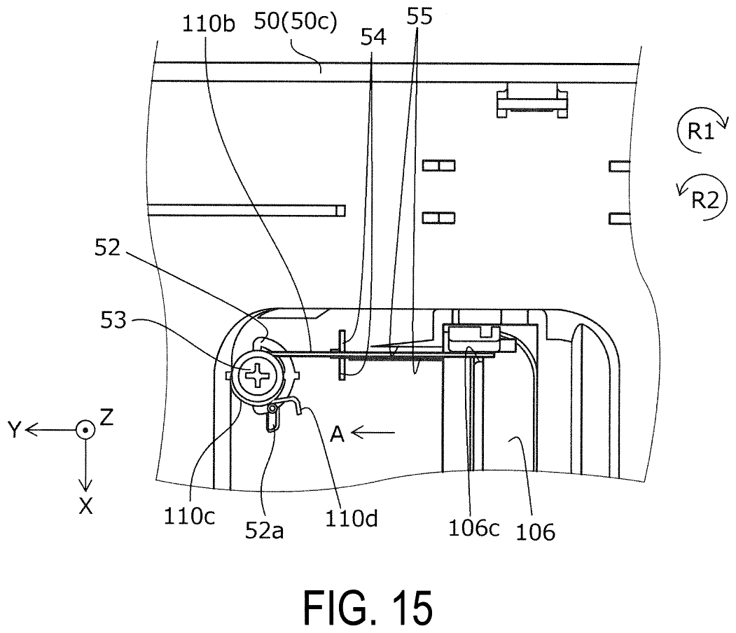

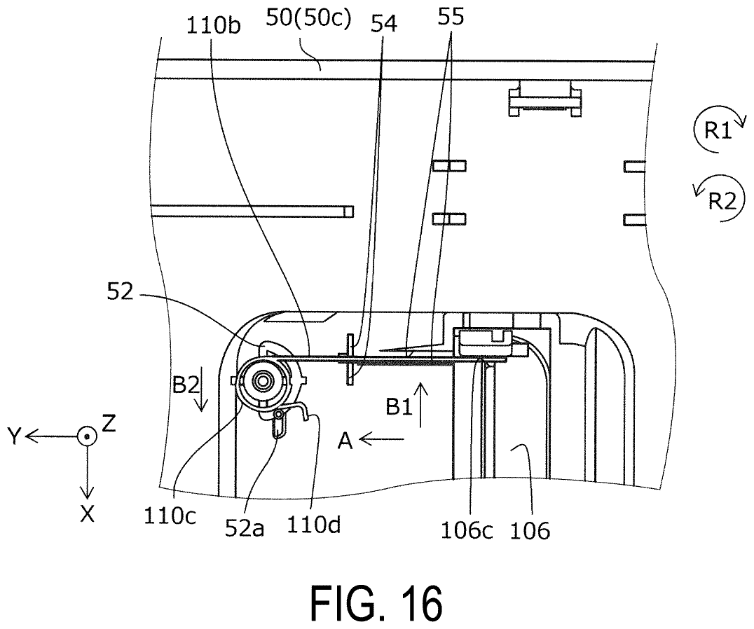

With reference to FIGS. 15 and 16, the lock mechanism 100 of the present example will be described in more detail. As described above, in the printer 1 of the present example, the linear part 110b is restricted from moving in the direction intersecting the side door 50 by the protrusion part 54, the groove part 55, and the slit 106c. The hook part 110d is hooked on a second restricting part 52a to restrict the rotation of the attachment part 110c. Therefore, as illustrated in FIG. 16, when the linear member 110 is set at the side door 50, a part on the tip end part 110a side relative to the attachment part 110c is applied with a force that causes the linear member 110 to open in B1 direction, and a part on the hook part 110d side relative to the attachment part 110c is applied with a force that causes the linear member 110 to open in B2 direction. Therefore, from the linear member, the protrusion part 54 is applied with a force in B1 direction, and the second restricting part 52a is applied with a force in B2 direction. Therefore, in this state, it is easy to maintain the linear member 110 in a state of being retained by the side door 50. Therefore, as illustrated in FIG. 15, at the time of subsequent screwing with a screw 53, it is no longer necessary for the user to press various parts of the linear member 110, and therefore screwing becomes easy.

Describing from the viewpoint of the second restricting part 52a, in the lock mechanism 100 of the present example, the side door 50 includes the screw receiver 52 and the second restricting part 52a configured to restrict rotation of the attachment part 110c by hooking the hook part 110d. The attachment part 110c is attached to the side door 50 by being inserted into the screw receiver 52, and the second restricting part 52a restricts rotation of the attachment part 110c inserted into the screw receiver 52. With such a configuration, the linear member 110 is configured to be easily assembled at a desired assembly position by inserting and screwing the attachment part 110c into the screw receiver 52. The second restricting part 52a restricts the rotation of the attachment part 110c, so that the work at the time of screwing is facilitated.

In the lock mechanism 100 of the present example, as illustrated in FIG. 4, the first member 100A includes the plurality of hook members 101, that is, the plurality of engagement parts 101a, and the pivot shaft 105, which is a shaft part attached with the plurality of hook members 101. With such a configuration, for example, the plurality of engagement parts 101a are interlocked by the pivot shaft 105, whereby the locking is configured to be more effectively performed.

As described above, in the lock mechanism 100 of the present example, the first member 100A includes the rotation transmission member 103 as the first abutment part on which the pressing spring 104 abuts. With such a configuration, for example, the pressing spring 104 applies a biasing force at one position to the plurality of engagement parts 101a, so that the number of pressing springs 104 is configured to be reduced and the cost is configured to be suppressed. However, the present disclosure is not limited to such a configuration. For example, a plurality of the pressing springs 104 may be provided, and each of the engagement parts 101a may be biased by the pressing spring 104.

As illustrated in FIG. 3, in the lock mechanism 100 of the present example, the side door 50 is openable and closable about the pivot shaft 50a along the Z-axis direction, that is, the vertical direction, and as illustrated in FIG. 4, the pivot shaft 105 extends along the vertical direction, and the rotation transmission member 103 is provided in the vertical direction between the hook member 101A and the hook member 101B, that is, between the plurality of engagement parts 101a. With such a configuration, by providing the first abutment part between the plurality of engagement parts 101a, the engagement part 101a is configured to be provided further on the axial end side of the pivot shaft 105. Therefore, locking is configured to be performed more effectively.

As described above, the operation lever 106 is a handle, and is an operation part for opening and closing the side door 50. Here, in the printer 1 of the present example, as illustrated in FIG. 8, the side door 50 includes a second abutment part 50d on which the operation lever 106 is configured to abut. With such a configuration, the operation lever 106 is configured to be biased toward the pivot direction R2 by the linear member 110 until the operation lever 106 abuts on the second abutment part 50d, and the position of the operation lever 106 with respect to the side door 50 is configured to be stabilized.

In the printer 1 of the present example, as illustrated in FIGS. 5 and 8, when the operation lever 106 is abutting on the second abutment part 50d, the operation lever 106 is flush with the outer surface of the side door 50. With such a configuration, the operation part is configured to be brought into a state of being flush with the outer surface, and the appearance is configured to be improved. Here, “flush” does not indicate only being completely flush, but also includes a case of being flush in consideration of measurement errors and manufacturing variations of members.

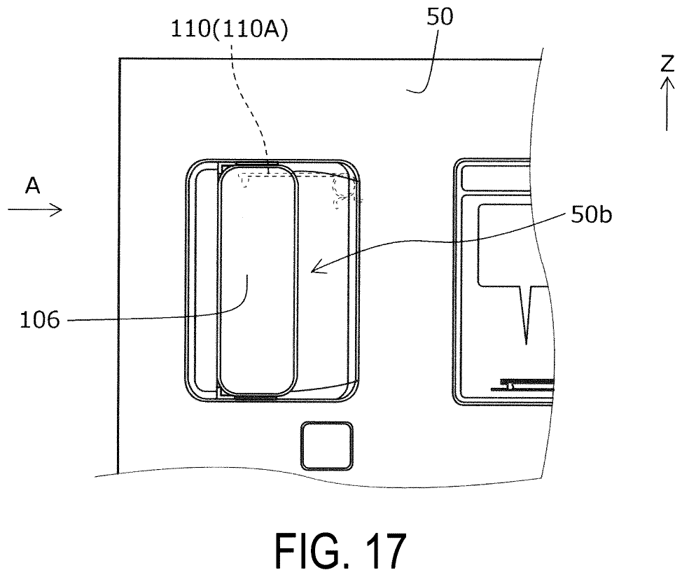

In the printer 1 of the present example, the linear member 110 is arranged with respect to the side door 50 in the arrangement illustrated in FIGS. 17, 18, 19, and the like. From another viewpoint, the linear member 110 is disposed at a position overlapping the operation lever 106 as viewed in a direction intersecting the outer surface of the side door 50 as illustrated in FIG. 17. With such a configuration, the linear member 110 is configured to be made less visible in the appearance, and the appearance is configured to be improved.

The printer 1 of the present example includes the housing mechanism including the lock mechanism 100, the outer cover of the device body 2, and the side door 50 as described above, and the conveyance unit including the plurality of conveyance roller pairs for conveying the medium P, such as the conveyance belt 13 and the conveyance roller pair 31, and the side door 50 forms at least a part of a conveyance path through which the medium P is conveyed by the conveyance unit. With such a configuration, the conveyance path is configured to be opened by opening and closing the side door 50, for example, and jam processing and the like is configured to be facilitated.

### Example 2

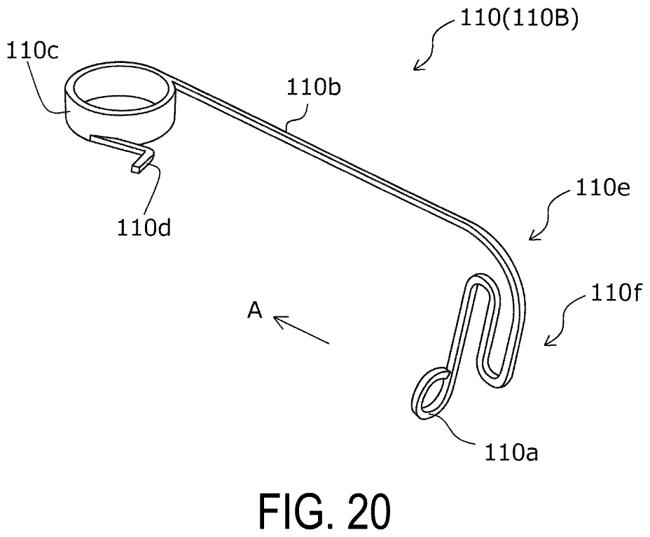

Next, the printer 1 of Example 2 will be described with reference to FIG. 20. In FIG. 20, constituent members common to those of Example 1 are denoted by the same reference signs, and a detailed description will be omitted. FIG. 20 is a view corresponding to FIG. 14 in the printer 1 of Example 1. Here, the printer 1 of the present example has the same configuration as that of the printer 1 of Example 1 except for the configuration of the linear member 110. Therefore, the printer 1 of the present example has the same features as those of the printer 1 of Example 1 except for the parts described below.

As illustrated in FIG. 20, in a linear member 110B in the printer 1 of the present example, an S-shaped crank part 110f is provided on the tip end part 110a side relative to the bend part 110e in the linear part 110b. Therefore, even when the linear part 110b is applied with a strong external force, the S-shaped crank part 110f is elastically deformed, so that the linear part 110b is less likely to be plastically deformed, and the durability of the linear member 110 is increased.

### Example 3

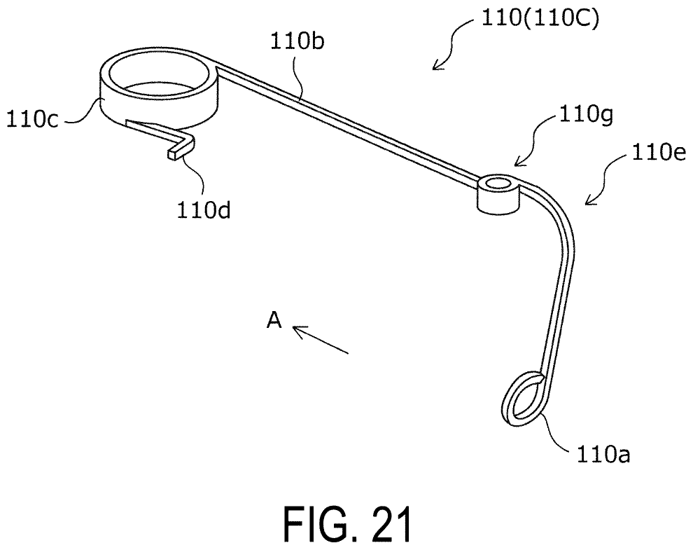

Next, the printer 1 of Example 3 will be described with reference to FIG. 21. In FIG. 21, constituent members common to those of Example 1 are denoted by the same reference signs, and a detailed description will be omitted. FIG. 21 is a view corresponding to FIG. 14 in the printer 1 of Example 1. Here, the printer 1 of the present example has the same configuration as that of the printer 1 of Example 1 except for the configuration of the linear member 110. Therefore, the printer 1 of the present example has the same features as those of the printer 1 of Example 1 except for the parts described below.

As illustrated in FIG. 21, the linear member 110C in the printer 1 of the present example is provided, on the attachment part 110c side relative to the bend part 110e in the linear part 110b, with a wound part 110g spirally wound. Therefore, even when the linear part 110b is applied with a strong external force, the wound part 110g is elastically deformed, so that the linear part 110b is less likely to be plastically deformed, and the durability of the linear member 110 is increased.

As described above, in the lock mechanisms 100 of Examples 2 and 3, the linear member 110 includes the deformation part likely to be elastically deformed by deforming the linear member 110 in the region between the attachment part 110c and the tip end part 110a. With such a configuration, by deforming the linear part 110b, a part involved in the biasing force of the linear member 110 is configured to be shortened, and a desired load is configured to be stably applied. Since the deformation part is easily elastically deformed, the displacement amount of the tip end part 110a is configured to be increased.

### Example 4

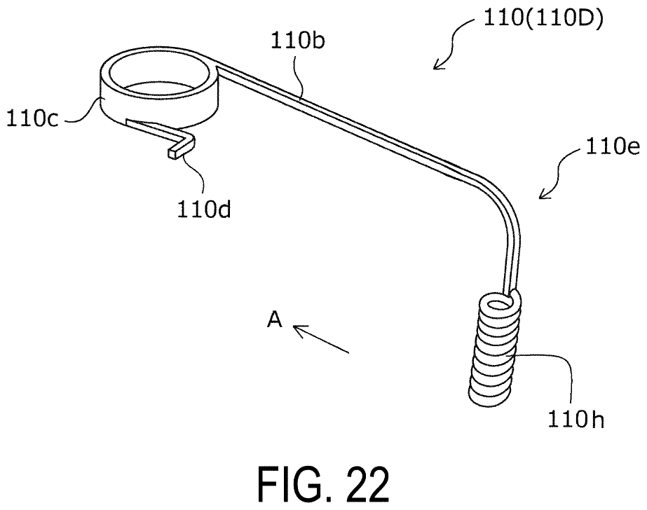

Next, the printer 1 of Example 4 will be described with reference to FIG. 22. In FIG. 22, constituent members common to those of Example 1 are denoted by the same reference signs, and a detailed description will be omitted. FIG. 22 is a view corresponding to FIG. 14 in the printer 1 of Example 1. Here, the printer 1 of the present example has the same configuration as that of the printer 1 of Example 1 except for the configuration of the linear member 110. Therefore, the printer 1 of the present example has the same features as those of the printer 1 of Example 1 except for the parts described below.

As illustrated in FIG. 22, a linear member 110D in the printer 1 of the present example is provided with a spiral part 110h wound long in a spiral shape on the tip end side of the linear part 110b. Therefore, even when the linear part 110b is applied with a strong external force, the spiral part 110h is elastically deformed, so that the linear part 110b is less likely to be plastically deformed, and the durability of the linear member 110 is increased.

The present disclosure is not limited to the above-described embodiment and modification examples, various modification is configured to be made within the scope of the disclosure as described in the appended claims, and it is needless to say that the modifications also fall within the scope of the present disclosure.

What is claimed is:

1. A lock mechanism that locks a door part being openable and closable with respect to a device body in a closed state of being closed with respect to the device body, the lock mechanism comprising:
a first member including an engagement part being engageable with the device body;
a first biasing member configured to bias the first member toward an engagement direction in which the engagement part engages with the device body;
a second member configured to displace the first member such that the engagement part shifts from an engaged state to a disengaged state with respect to the device body against a biasing force by the first biasing member; and
a second biasing member configured to bias the second member, wherein
a biasing force of the second biasing member does not resist the biasing force by the first biasing member.

2. The lock mechanism according to claim 1, wherein
the second biasing member is a linear member including a first end part attached to the door part, and a second end part located opposite the first end part and abutting on the second member.

3. The lock mechanism according to claim 2, wherein
the second end part is slidable with respect to the second member.

4. The lock mechanism according to claim 3, wherein
the second end part includes a bent part abutting on the second member.

5. The lock mechanism according to claim 2, wherein
the second biasing member includes a restricted part restricted from moving in a direction intersecting an extension direction of the second biasing member, in a region between the first end part and the second end part.

6. The lock mechanism according to claim 2, wherein
the second biasing member includes a deformation part in which the linear member is deformed, in a region between the first end part and the second end part.

7. The lock mechanism according to claim 1, wherein
the first member includes a plurality of the engagement parts and a shaft part attached with the plurality of engagement parts.

8. The lock mechanism according to claim 7, wherein
the first member includes a first abutment part on which the first biasing member abuts.

9. The lock mechanism according to claim 8, wherein
the door part is openable and closable about a pivot shaft along a vertical direction,
the shaft part extends along a vertical direction, and
the first abutment part is provided between a plurality of the engagement parts in a vertical direction.

10. A housing mechanism comprising:
the lock mechanism according to claim 5;
the device body;
the door part; and
a sheet metal attached to the door part, wherein
the door part includes a first restricting part configured to restrict the restricted part from moving in a direction along the door part, and
the restricted part is positioned between the door part and the sheet metal, and is restricted from moving in a direction intersecting the door part.

11. A housing mechanism comprising:
the lock mechanism according to claim 2;
the device body; and
the door part, wherein
the door part includes a screw receiver and a second restricting part configured to restrict rotation of the first end part,
the first end part is attached to the door part by being inserted into the screw receiver, and
the second restricting part is configured to restrict rotation of the first end part inserted into the screw receiver.

12. A housing mechanism comprising:
the lock mechanism according to claim 1;
the device body; and
the door part, wherein
the second member is an operation part for opening and closing the door part, and
the door part includes a second abutment part on which the second member is configured to abut.

13. The housing mechanism according to claim 12, wherein
when the second member is abutting on the second abutment part, the operation part is flush with an outer surface of the door part.

14. The housing mechanism according to claim 12, wherein
the second biasing member overlaps the second member as viewed in a direction intersecting an outer surface of the door part.

15. A medium conveyance device comprising:
the housing mechanism according to claim 11; and
a conveyance unit configured to convey a medium, wherein
the door part forms at least a part of a conveyance path through which a medium is conveyed by the conveyance unit.

16. A medium conveyance device comprising:
the housing mechanism according to claim 12; and
a conveyance unit configured to convey a medium, wherein
the door part forms at least a part of a conveyance path through which a medium is conveyed by the conveyance unit.
